(19) United States
(12) Patent Application Publication
(10) Pub. No.: US 2010/0199630 A1
(43) Pub. Date: Aug. 12, 2010

(54) Compact combined cycle vortex turbine engine with internal steam generator and vapor innercooling

(76) Inventor: Harry Eugene Belcher, Lakeland, FL (US)

Correspondence Address: HARRY E. BELCHER, 4504 MT. VIEW DR., LAKELAND, FL, 33813, US

(21) Appl. No.: 12/322,945

(22) Filed: Feb. 10, 2009

(51) Int. Cl. F02C 6/00; F01K 23/06

(52) U.S. Cl. 60/39.182

(57) ABSTRACT

A compact, combined cycle gas and steam turbine engine for lower temperature,lower RPM's, and higher torque than a standard gas turbine, while maintaining the lower turbine weight ratio over internal combustion engines. This turbine has a cylindrical combustion chamber, containing a tube boiler spiraled around the inside, in a manner to create a vortex type combustion gas flow, which drives the primary turbine blades. The steam created in this boiler tube jetted against the secondary turbine blades adds torque. The hot combustion gasses are compressed, and passed into the steam stream to reheat and reexpand the steam, which also lowers the exhaust temperature. Unlike most turbine cylinders which turn the inside cylinder this is the only one which turns the outward cintrifical pressured cylinder, which means greater efficiency. The circular exhaust has air induction to increase power and help cool a normally hot exhaust. Water vapor and cooled exhaust from the manifold is ducted between the combustion chamber and outter wall for intercooling the engine and increasing output of the fuel. Existing electronic controls may easily be added.

This invention relates generally to combined cycle turbine engines and, more particularly, to compact combined-cycle gas-steam turbine engines for generators or other standard applications.

### BACKGROUND OF THE INVENTION

It has long been known combined cycle turbine engines use the waste heat from gas turbine engines to heat a boiler creating steam to drive a separate steam turbine engine. In this configuration combined cycle turbine engines are limited to large stationary applications. Construction of a combined cycle turbine is very expensive and it is very complicated to operate.

It is desireable to provide such an engine which is less costly, more compact and operates on alternate fuels and water. The efficiency of combined cycle turbine engines is well documented as being one of the highest. This is why development of this turbine is important to supply energy at lower cost and higher efficiency with less polutants being released into our atmosphere, than with standard gas engines.

### BRIEF SUMMARY OF THE INVENTION

It is a principal object of my invention to provide a new and improved turbine for generators or other various uses. More specifically it is an object of the invention to provide such a combination gas and steam turbine, wherein alternate less expensive fuels may be used for combustion, lowering operating cost. Moreover this turbine operates at a lower temperature than gas turbines making it more desireable for different applications. Lower operating temperatures means this turbine dosen't require expensive exotic metals or ceramics in its construction.

The embodiment of this invention achieves the forgoing objects in a combination gas and steam turbine engine, including a rotor having turbine blades for compressing intake air. A gas jet inserted into a mixing tube leading to an igniter for primary combustion. A chamber containing a boiler & tube wound around the outter wall in such a manner as to create a spiraling vortex type air passage for the combustion gasses. And turbine blades attached to the outter rotating wall being driven by the vortex type gas rotation, originating from the combustion of the ignited gas coming from the mixing tube. This hot combustion gas heats the boiler tube generating steam, which is then compressed through jets pointed at the secondary turbine blades adding torque to the rotor. The vortex type combustion chamber gases, still rotating, are then compressed through the opening between the boiler tube and the rotor, at the point of the blade reinforcing flange, which puts these combustion gasses into the same chamber as the steam, heating the steam and in turn cooling the exhaust. This combined stream of gasses are spiraling around a circular drive chamber to the exhaust port, adding more torque to the secondary turbine blade drive, thus increasing efficiency remarkably. The innercooling of the turbine is done by ducting cooled exhaust into the combustion chamber and aided by the arrangment of small turbine type blades and the main intake compressor, which in this example application draws cooling air through and around the generator. Small blades attop the main rotor push air between the wall of the turbine housing and the inner rotor wall, which is then compressed by the small blades on the inside of the housing causing rotation to the exhaust stream.

### BRIEF DESCRIPTION OF THE SEVERAL VIEWS OF THE DRAWINGS

FIG. 1 is a schematic, cross-sectional view of my compact combined cycle turbine engine in accordance with the present invention.

FIG. 2 is a cross-sectional view of the vortex type combustion chamber containing boiler tubes, steam jets, the primary,and secondary turbine blades and the curved combustion tube with related fuel and steam control configurations needed for construction taken on line 2-2 of FIG. 1.

### DETAILED DESCRIPTION OF THE INVENTION

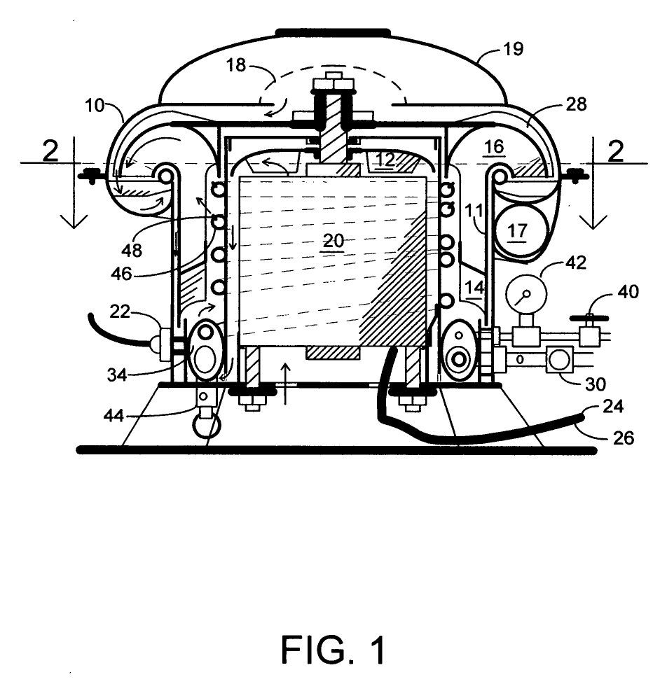

Referring to the drawings, and first to FIG. 1 the reference number 10 designates generally a combined cycle gas-steam turbine engine for generators or other applications, containing a cylindrical rotor 11 with an attachment generator 20 coupled to the intake rotor 12, also primary turbine blades 14 are attached to the inner upright walls with the secondary turbine blades 16 rising and rolling over the upper curved portion of said wall, with the small cooling blades 28 above them on the outter side of the top wall. The generator leads, just for clarity of this application of this turbine, are for battery leads 24 and for output leads 26. The compressed gas torch with valve 30 is inserted into the primary boiler tube 34, and then ignited by the igniter 22. The steam tube 46 is supplied thru water valve 40 which is monitored by pressure gauge 42 and protected from overpressure by relief valve 44 and vent piped into the exhaust chamber 17 in case of over-pressurizing the steam The steam jets 48 on the side of the steam tube 46 pointed at the secondary turbine blades 16. The innercooling works by recirculating the mixture of steam and cooled exhaust gasses. The cooling filter 18 and the insulated handle 19 are on top of the turbine 10.

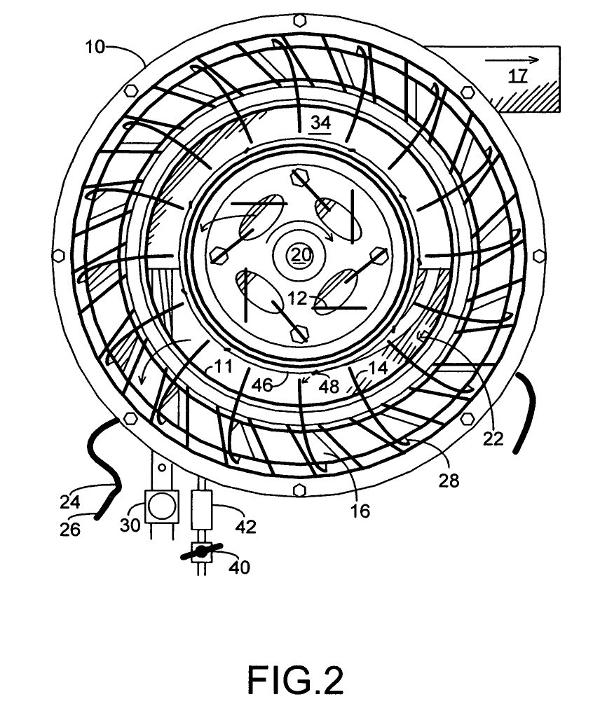

Referring to FIG. 2 this cross-section shows the cylindrical shape of the housing 10 and the steam pipe 46 spiraled around the outside of the inner wall, along with the primary boiler and combustion pipe 34 creating a vortex type combustion chamber, driving the primary turbine blades 14 and causing rotor 11 to rotate in the same direction as the expanding vortex type gas flow. Still rotating, the gas flow is then compressed thru a port between the boiler tube and the rotor flange connecting it to main drive turbine blades 16 which is driven by steam jets 48 combined with the compressed gas flow. This steam and gas combination then compresses into the cylindrical shaped exhaust 17 and aided by cooling blades 18 creates a rotating exhaust stream for kinetic energy for pushing the secondary turbine blades in the correct rotation.

This turbine is constructed of standard sheetmetal of various thicknesses, cut, broken, rolled, and welded in a standard metals shop, then balanced by a balancing shop for opptimum performance. Persons experienced in this field would have no problems building or operating this turbine, even adapting it for another purpose. It may be adaped to run off of any standard fuel, and some not so standard. A off the shelf generator and igniter may be used, and this turbine is self starting when ignited, elliminating the need for a starter motor. The valves, tubing, and gages are available at most hardware stores. A person in this trade should have no trouble constructing this turbine, because it is based on known principles with low tolerances, high torque and the size is adaptable to hybrid automobiles, home, camping, even heating among a few of the many applications.

From the preceding discription there has been set forth the preferred embodiment of the present invention, it is evident that the objects of the invention are attained. Although the invention has been described and illustrated in detail it is clearly understood that the same is intended by way of illustration and example only and is not to be taken by way of limitation. Accordingly, the spirit and scope of the invention are to be limited only by the terms of the appended claims.

What I claim as my invention is:

1. A compact combined cycle turbine engine comprising: a cylindrical combustion chamber containing a boiler and tube coiled about in such a manner as to sustain a spiraling vortex type combustion gas flow, created by igniting gas in a curved combustion pipe at one end; and a rotor including primary turbine blades angled to be driven by the gas flow, with secondary turbine blades attached in a second joining chamber driven by steam jets, and also by a combination of steam and these combustion gasses.

2. A combined cycle turbine engine in accordance with claim 1 further comprising a shell, containing a cylindrical exhaust housing with air induction creating a rotational thrust, to increase the torque on the secondary turbine blades.

3. A combined cycle turbine engine in accordance with claim 1 having a self contained steam generator and pipe with steam nozzles.

4. A combined cycle turbine engine in accordance with claim 1 having a exhaust vapor intercooled combustion chamber.

5. Primary turbine blades located to the inside of the rotated drum utilizing centrifical force, increasing kenetic pressure to increase efficiency.

6. Rotor blades that compress air into the exhaust chamber, cooling the vapor mix forced between the combustion chamber wall and the outter housing wall, for innercooling boost.
